(19) United States
(12) Patent Application Publication
(10) Pub. No.: US 2015/0035980 A1
(43) Pub. Date: Feb. 5, 2015

(54) IMAGE CAPTURING DEVICE FOR A VEHICLE

(71) Applicant: Dieter Krökel, Eriskirch (DE)

(72) Inventor: Dieter Krökel, Eriskirch (DE)

(73) Assignee: CONTI TEMIC MICROELECTRONIC GMBH, Nürnberg (DE)

(21) Appl. No.: 14/128,693

(22) PCT Filed: Jul. 2, 2012
(86) PCT No.: PCT/DE2012/100194

§ 371 Date: Feb. 19, 2014

(30) Foreign Application Priority Data
Jul. 5, 2011 (DE) 10 2011 051 583.6

(51) Int. Cl. B60R 1/00; G06K 9/00

(52) U.S. Cl. CPC B60R 1/00; G06K 9/00791; B60R 2300/8053; B60R 2300/804
USPC 348/148

(57) ABSTRACT

The invention relates to an image capturing device comprising an image sensor. A first polarizing filter is arranged in at least one first subarea in front of the image sensor while a second polarizing filter is arranged in at least one second subarea. The polarizing filters have different directions of polarization (h;v). The image capturing device of the invention comprises an evaluation unit which is able to detect the presence of polarized light by comparing the intensities of the at least two subareas that are polarized differently. In other words, the intensity in the subarea of the image sensor which receives electromagnetic radiation that has passed through the first polarizing filter is compared with the intensity in the subarea of the image sensor which receives electromagnetic radiation that has passed through the second polarizing filter.

### CROSS REFERENCE TO RELATED APPLICATIONS

This application is the U.S. National Phase Application of PCT/DE2012/100194, filed Jul. 2, 2012, which claims priority to German Patent Application No. 10 2011 051 583.6, filed Jul. 5, 2011, the contents of such applications being incorporated by reference herein.

### FIELD OF THE INVENTION

The invention relates to an image capturing device for a vehicle and a method for detecting moisture on a road.

### BACKGROUND OF THE INVENTION

Accident prevention is an increasingly important aspect of driver assistance systems. Emergency braking systems make a major contribution in this regard. However, their effectiveness essentially depends on the coefficient of friction of the road surface. In particular in wet conditions, the coefficient of friction is much lower than that on a dry road.

JP 2010-243463 A, which is incorporated by reference, shows a vehicle-mounted stereo camera where two pairs of lenses for different ranges of vision and two image sensors are used to produce a stereo image for a near range and a stereo image for a far range. The different areas of vision are separated by means of polarizers or polarizing filters which are arranged at right angles and in parallel.

In an emergency braking system, such a stereo camera could be used to detect objects and to measure the relative speed.

DE 102005062275 A1, which is incorporated by reference, shows a method for detecting an imminent rear-end collision by means of a rearward distance and/or relative speed sensor. For the purpose of evaluating the relative speed of a vehicle approaching the own vehicle from behind, the current coefficient of friction can be corrected to a lower value when the rain sensor detects rain.

The drawbacks of this method are, among others, that a separate rain sensor is required to correct the coefficient of friction and that moisture on the vehicle is detected rather than moisture on the road.

### SUMMARY OF THE INVENTION

An aspect of the present invention detects moisture on the road in a cost-efficient and reliable manner.

According to an aspect of the invention, this is achieved by means of an image capturing device comprising an image sensor. A first polarizing filter is arranged in at least one first subarea in front of the image sensor while a second polarizing filter is arranged in at least one second subarea. The polarizing filters have different directions of polarization. The image capturing device of the invention comprises an evaluation unit which is able to detect the presence of polarized light by comparing the intensities of the at least two subareas that are polarized differently. In other words, the intensity in the subarea of the image sensor which receives electromagnetic radiation that has passed through the first polarizing filter is compared with the intensity in the subarea of the image sensor which receives electromagnetic radiation that has passed through the second polarizing filter.

The invention is based on the idea that a wet surface has an effect on the polarization characteristic of reflected, previously non-polarized light, in such a manner that the polarization in the direction of the plane of incidence is preferably transmitted, while the polarization at right angles to the plane of incidence is preferably reflected.

If this scene is viewed with an image capturing device of the invention, in the beam path of which polarizers arranged at right angles are placed in at least two subareas, a difference in contrast can be detected between the two subareas for the wet road area, and according to a preferred embodiment, it can be concluded that there is moisture, which results in a lower coefficient of friction than on a dry road.

One advantage of the invention is that moisture can be detected in a reliable and cost-efficient manner by means of an image capturing device comprising a single image sensor, i.e. by means of a mono camera.

In an advantageous embodiment, the image sensor comprises a plurality of sensor elements which are arranged next to each other in the form of a matrix and are sensitive to electromagnetic radiation. Filter elements are assigned to the sensor elements by means of a filter pixel matrix, so that each sensor element detects electromagnetic radiation from a specific wavelength range or with a specific direction of polarization. It is also possible that several adjacent sensor elements are assigned to an identical filter element of the filter pixel matrix. If the polarizers are included in the filter pixel matrix, the polarizers can be optimally distributed on the one hand and the color information of the detected image sensor signal is substantially retained on the other. Polarizers reduce the light intensity of non-polarized light by approx. 50%. In addition, another 10% is lost due to reflection and absorption. To ensure that the sensitivity of cameras for automobile applications is still high enough, in particular at night, a light loss of approx. 60%, as is the case in polarizing filters having a continuous surface, cannot be tolerated. If the color and polarizing filter elements are distributed in a pixel pattern instead, an approximately homogeneous signal height is achieved since the transmission loss of a polarizing filter element is in the order of magnitude of the color filter element which is no longer present.

In addition, the polarizers have hardly any effect on a grayscale image generated for the purpose of detecting edges and shapes.

Further advantageous configurations of the image capturing device of the invention are set out in the subclaims and in the exemplary embodiments.

The invention further relates to a method for detecting moisture on a road by means of an image capturing device of the invention. Said device comprises polarizing filters (h;v) with different orientations in at least two subareas in front of an image sensor. Once the image sensor has captured an image, moisture on the road is detected by comparing the intensities of the at least two subareas (h;v) that are polarized differently. The difference in intensity results from the fact that the portions that are polarized differently are reflected differently on the wet road. Light polarized in parallel (vertically) is transmitted to a greater degree, while light polarized at right angles (horizontally) is reflected to a greater degree on the wet surface and is thus detected to a greater degree by the image sensor.

### BRIEF DESCRIPTION OF THE DRAWINGS

Hereinafter, exemplary embodiments of the invention will be described with reference to the figures, in which:

FIG. 1 shows a filter pixel matrix which is composed of modified Bayer matrices and comprises polarizers whose orientation varies from one line to the other;

FIG. 2 shows a filter pixel matrix comprising square groups of polarizers arranged at right angles to each other, resembling a chess board pattern.

### DETAILED DESCRIPTION OF THE INVENTION

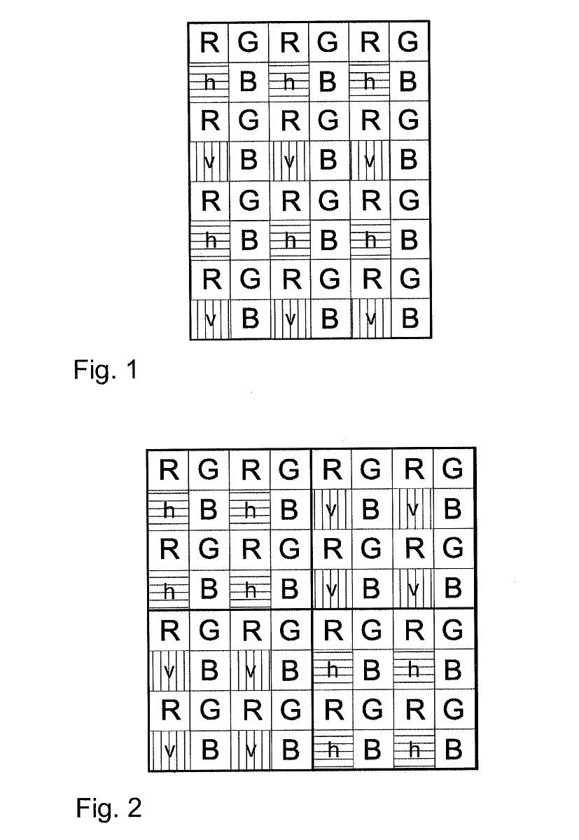

FIG. 1 shows a filter pixel matrix for the image sensor, corresponding to a modified Bayer color filter where each fourth pixel is provided with a polarizer. In the shown case, the green filter element in the second line of an original 2×2 Bayer color filter (R,G,G,B) has been replaced with a polarizer (R,G,h/v,B). The two directions of polarization are at right angles or horizontal (h, horizontal hatching) on the one hand and in parallel or vertical (v, vertical hatching) on the other. In the filter matrix of FIG. 1, the second green Bayer filter element has been replaced in such a manner that the lines including polarizers alternate: 1st line: no polarizers, 2nd line: horizontal polarizers (h), 3rd line: no polarizers, 4th line: vertical polarizers (v).

The polarizers are arranged in such a manner that those in one line are at right angles to those in the next. In case of non-polarized light, there will be no visible line-patterned brightness or intensity structure. In case of partially polarized light, as results from reflection on wet roads, those image areas of the image sensor where the wet road is imaged will have an additional line-patterned brightness structure, which can be detected by the evaluation unit by means of image processing algorithms. If such a line-patterned brightness structure is successfully detected, the evaluation unit transmits a “Wet road” signal to the control unit of the emergency braking assistant or to another assistance system, which can now adapt the time of braking and the braking force to a wet road.

Today's wafer level technologies allow polarizers to be placed directly on the silicon wafer of the image sensor. In addition, the polarizers can be structured in a size corresponding to that of pixels, i.e. a few μm.

Of course, the polarizers may also be arranged in the filter pixel matrix in another way in order to be able to detect moisture. In FIG. 2, the polarizers having the same direction of polarization are grouped in squares of 4×4 filter elements, i.e. four 2×2 matrices. In case of an arrangement as in FIG. 2, the image processing algorithm of the evaluation unit must search for square differences in brightness. The shown arrangement results in a chess board pattern of the differences in brightness of the filter elements provided with polarizers if the road surface is wet. If however non-polarized light is present, there will be no differences in brightness according to the pattern of arrangement.

In general, the groups or matrices including different polarizers should be aligned in such a manner that they cannot be confused with natural structures. The arrangement used may also be selected according to the size from which wet road areas should be detected.

1. An image capturing device for a vehicle, comprising an image sensor, wherein a first polarizing filter (h) is arranged in at least one first subarea and a second polarizing filter (v) is arranged in at least one second subarea, wherein the polarizing filters (h;v) have different directions of polarization, wherein the image capturing device comprises an evaluation unit which is able to detect polarized light by comparing the intensities of the at least two subareas that are polarized differently.

2. The image capturing device according to claim 1, wherein the evaluation unit is able to detect a wet road by comparing the intensities of the subareas that are polarized differently.

3. The image capturing device according to claim 1, wherein the image sensor comprises a plurality of sensor elements which are arranged next to each other in the form of a matrix and are sensitive to electromagnetic radiation, and wherein filter elements (R;G;B;h;v) are assigned to the sensor elements by means of a filter pixel matrix, so that each sensor element detects electromagnetic radiation from a specific wavelength range (R;G;B) or with a specific direction of polarization (h;v).

4. The image capturing device according to claim 3, wherein the filter pixel matrix is composed of two different 2×2 matrices which differ with regard to their direction of polarization (h;v).

5. The image capturing device according to claim 4, wherein the first 2×2 matrix comprises one filter element for each of red, green, first direction of polarization and blue (R,G,h,B), and the second 2×2 matrix comprises one filter element for each of red, green, second direction of polarization and blue (R,G,v,B).

6. The image capturing device according to claim 4, wherein the different 2×2 matrices (R,G,h,B and R,G,v,B) alternate with each other in the form of lines in the structure of the filter pixel matrix.

7. The image capturing device according to claim 4, wherein the different 2×2 matrices (R,G,h,B and R,G,v,B) alternate with each other in the form of columns in the structure of the filter pixel matrix.

8. The image capturing device according to claim 4, wherein the filter pixel matrix is composed of square arrangements of the different 2×2 matrices (R,G,h,B and R,G,v,B), resembling a chess board.

9. A method for detecting moisture on a road by an image capturing device comprising polarizing filters (h;v) with different orientations in at least two subareas in front of an image sensor, wherein moisture on the road is detected by comparing the intensities of the at least two subareas (h;v) that are polarized differently.
